(19) United States
(12) Patent Application Publication
(10) Pub. No.: US 2023/0103133 A1
(43) Pub. Date: Mar. 30, 2023

(54) WELL ACTIVITY MANAGEMENT

(71) Applicant: Nabors Drilling Technologies USA, Inc., Houston, TX (US)

(72) Inventors: Mohammad HAMZAH, Katy, TX (US); Carlos ROLONG, Spring, TX (US)

(21) Appl. No.: 17/934,596

(22) Filed: Sep. 23, 2022

Related U.S. Application Data
(60) Provisional application No. 63/261,813, filed on Sep. 29, 2021.

(51) Int. Cl. G06Q 10/06

(52) U.S. Cl. CPC G06Q 10/063114; G06Q 10/06312

(57) ABSTRACT

A method can include collecting sensor data from one or more data sources, determining actual well activity being performed at the rig, determining an estimated well activity for the rig, comparing the actual well activity to expected well activity in a digital well plan; and setting a confidence level for the estimated well activity, where the confidence level can indicate a degree of confidence in an accuracy of the estimated well activity. A method can include collecting parameter(s) from data source(s), determining rig tasks being performed at the rig, determining a well activity for the rig, identifying secondary operations that are occurring at the same time as primary activities, comparing the secondary operations to a digital well plan, and determining whether the secondary operations are occurring at a proper time to support future primary activities.

### CROSS-REFERENCE TO RELATED APPLICATION(S)

This application claims priority under 35 U.S.C. § 119(e) to U.S. Provisional Application No. 63/261,813, entitled “WELL ACTIVITY MANAGEMENT,” by Mohammad HAMZAH et al., filed Sep. 29, 2021, which is assigned to the current assignee hereof and incorporated herein by reference in its entirety.

### TECHNICAL FIELD

The present invention relates, in general, to the field of drilling and processing of wells. More particularly, present embodiments relate to a system and method for detecting rig states, determining unplanned activities, and tracking simultaneous support activities during subterranean operations.

### BACKGROUND

During well construction operations, tasks on a rig can be organized according to a well plan. The well plan can be converted to a rig plan (i.e., rig specific well construction plan) for implementation on a specific rig. Deviations from the well plan or rig plan can cause rig delays, increase well site operation costs, and cause other impacts to operations. Delays in identifying the deviations can exacerbate these impacts. Therefore, improvements in well plan monitoring and reporting are continually needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for performing subterranean operations. The method also includes collecting sensor data from one or more data sources, where the sensor data is representative of conditions at a rig; based on the sensor data, determining actual rig tasks being performed at the rig; based on the actual rig tasks, determining an estimated well activity for the rig; comparing the actual rig tasks to expected rig tasks in a digital rig plan; based on the comparing, setting a confidence level for the estimated well activity, where the confidence level indicates a degree of confidence in an accuracy of the estimated well activity being an actual well activity; and comparing, via a rig controller, the estimated well activity to an expected well activity in a digital well plan. Other embodiments of this aspect include corresponding computer systems, apparatus, and computer programs recorded on one or more computer storage devices, each configured to perform the actions of the methods.

One general aspect includes a method for performing subterranean operations, which can include The method also includes collecting one or more parameters from one or more data sources, where the one or more parameters are representative of at least one condition that affects at least one operation of a rig; based on the one or more parameters, determining rig tasks being performed at the rig; based on the rig tasks, determining a well activity for the rig; identifying secondary operations that are occurring at the same time as primary activities; comparing, via a rig controller, the secondary operations to a digital well plan. The method also includes based on the comparing, determining whether the secondary operations are occurring at a proper time to support future primary activities. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative simplified front view of a rig being utilized for a subterranean operation, in accordance with certain embodiments;

FIG. 1B is a representative simplified view of a user using possible wearable devices for user input or identification, in accordance with certain embodiments;

FIG. 2 is a representative partial cross-sectional view of a rig being utilized for a subterranean operation, in accordance with certain embodiments;

FIG. 3 is a representative front view of various users detected via imaging system, in accordance with certain embodiments;

FIG. 4A is a representative list of well activities for an example digital well plan, in accordance with certain embodiments;

FIG. 4B is a functional diagram that illustrates conversion of well plan activities to rig plan tasks, in accordance with certain embodiments;

FIG. 5 is a flow diagram that shows secondary operations in support of primary activities, in accordance with certain embodiments;

FIG. 6 is a functional block diagram identifying an estimated well activity and determining a confidence level for the estimated well activity, in accordance with certain embodiments; and

FIGS. 7A and 7B are a flow diagram of a method 300 of determining planned/unplanned activities on a rig when compared to a desired well plan, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

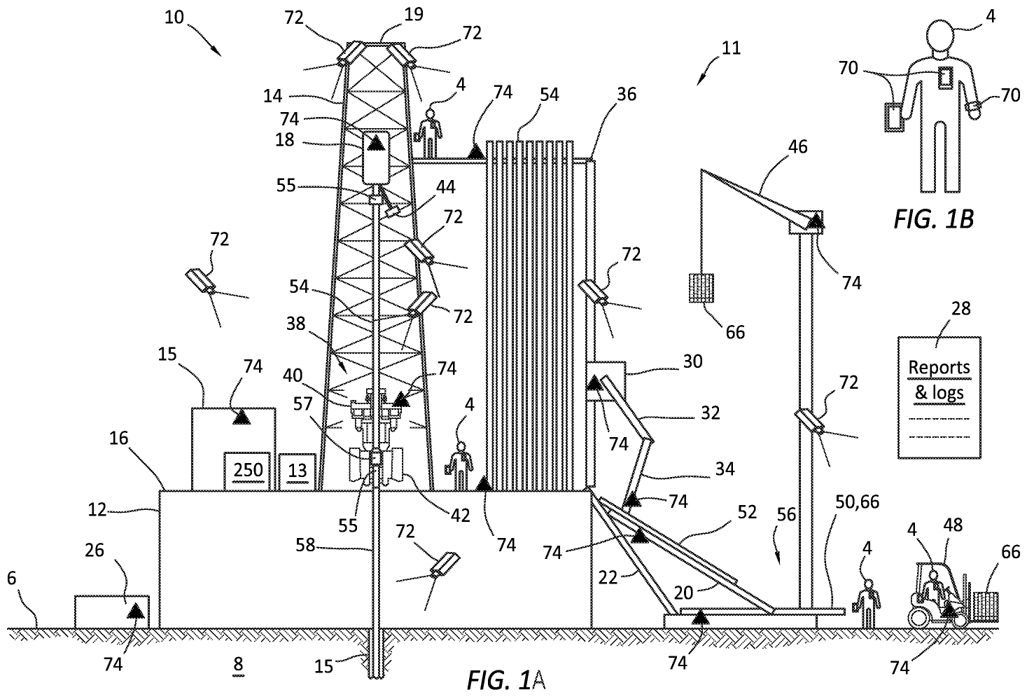

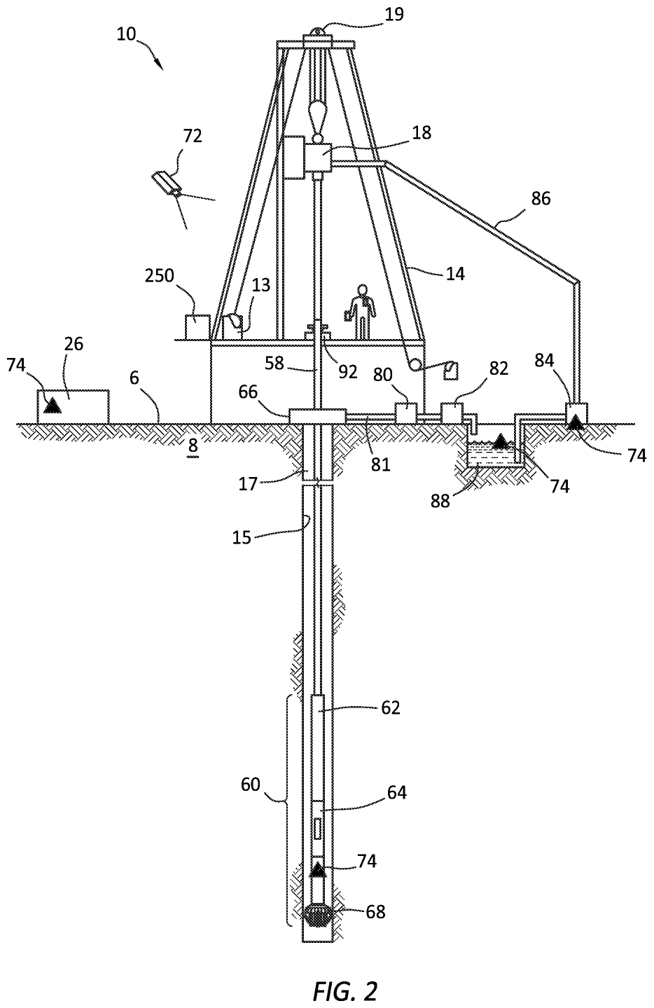

As used herein, “tubular” refers to an elongated cylindrical tube and can include any of the tubulars manipulated around a rig, such as tubular segments, tubular stands, tubulars, and tubular string, but not limited to the tubulars shown in FIG. 1A. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

FIG. 1A is a representative simplified front view of a rig 10 at a rig site 11 being utilized for a subterranean operation (e.g., tripping in or out a tubular string to or from a wellbore), in accordance with certain embodiments. The rig site 11 can include the rig 10 with its rig equipment, along with equipment and work areas that support the rig 10 but are not necessarily on the rig 10. The rig 10 can include a platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the fingerboard 36, the wellbore 15, etc. However, it is not required that a pipe handler 30 be used on the rig 10. The top drive 18 can transfer tubulars directly to and directly from the catwalk 20 (e.g., using an elevator coupled to the top drive).

The tubular string 58 can extend into the wellbore 15, with the wellbore 15 extending through the surface 6 into the subterranean formation 8. When tripping the tubular string 58 into the wellbore 15, tubulars 54 are sequentially added to the tubular string 58 to extend the length of the tubular string 58 into the earthen formation 8. FIG. 1A shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 are sequentially removed from the tubular string 58 to reduce the length of the tubular string 58 in the wellbore 15. The pipe handler 30 can be used to remove the tubulars 54 from an iron roughneck 38 or a top drive 18 at a well center 24 and transfer the tubulars 54 to the catwalk 20, the fingerboard 36, etc. The iron roughneck 38 can break a threaded connection between a tubular 54 being removed and the tubular string 58. A spinner assembly 40 can engage a body of the tubular 54 to spin a pin end 57 of the tubular 54 out of a threaded box end 55 of the tubular string 58, thereby unthreading the tubular 54 from the tubular string 58.

When tripping the tubular string 58 into the wellbore 15, tubulars 54 are sequentially added to the tubular string 58 to increase the length of the tubular string 58 in the wellbore 15. The pipe handler 30 can be used to deliver the tubulars 54 to a well center on the rig floor 16 in a vertical orientation and hand the tubulars 54 off to an iron roughneck 38 or a top drive 18. The iron roughneck 38 can make a threaded connection between the tubular 54 being added and the tubular string 58. A spinner assembly 40 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection.

While tripping a tubular string into or out of the wellbore 15 can be a significant part of the operations performed by the rig, many other rig tasks are also needed to perform a well construction according to a digital well plan. For example, pumping mud at desired rates, maintaining downhole pressures (as in managed pressure drilling), maintaining and controlling rig power systems, coordinating and managing personnel on the rig during operations, performing pressure tests on sections of the wellbore 15, cementing casing string in the wellbore, performing well logging operations, as well as many other rig tasks.

A rig controller 250 can be used to control the rig 10 operations including controlling various rig equipment, such as the pipe handler 30, the top drive 18, the iron roughneck 38, the fingerboard equipment, imaging systems, various other robots on the rig 10 (e.g., a drill floor robot), or rig power systems 26. The rig controller 250 can control the rig equipment autonomously (e.g., without periodic operator interaction,), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation).

The rig controller 250 can include one or more processors with one or more of the processors distributed about the rig 10, such as in an operator's control hut, in the pipe handler 30, in the iron roughneck 38, in the vertical storage area 36, in the imaging systems, in various other robots, in the top drive 18, at various locations on the rig floor 16 or the derrick 14 or the platform 12, at a remote location off of the rig 10, at downhole locations, etc. It should be understood that any of these processors can perform control or calculations locally or can communicate to a remotely located processor for performing the control or calculations. Each of the processors can be communicatively coupled to a non-transitory memory, which can include instructions for the respective processor to read and execute to implement the desired control functions or other methods described in this disclosure. These processors can be coupled via a wired or wireless network. All data received and sent by the rig controller 250 is in a computer-readable format and can be stored in and retrieved from the non-transitory memory.

The rig controller 250 can collect data from various data sources around the rig (e.g., sensors, user input, local rig reports, etc.) and from remote data sources (e.g., suppliers, manufacturers, transporters, company men, remote rig reports, etc.) to monitor and facilitate the execution of a digital well plan. A digital well plan is generally designed to be independent of a specific rig, where a digital rig plan is a digital well plan that has been modified to incorporate the specific equipment available on a specific rig to execute the well plan on the specific rig, such as rig 10. Therefore, the rig controller 250 can be configured to monitor and facilitate the execution of the digital well plan by monitoring and executing rig tasks in the digital rig plan.

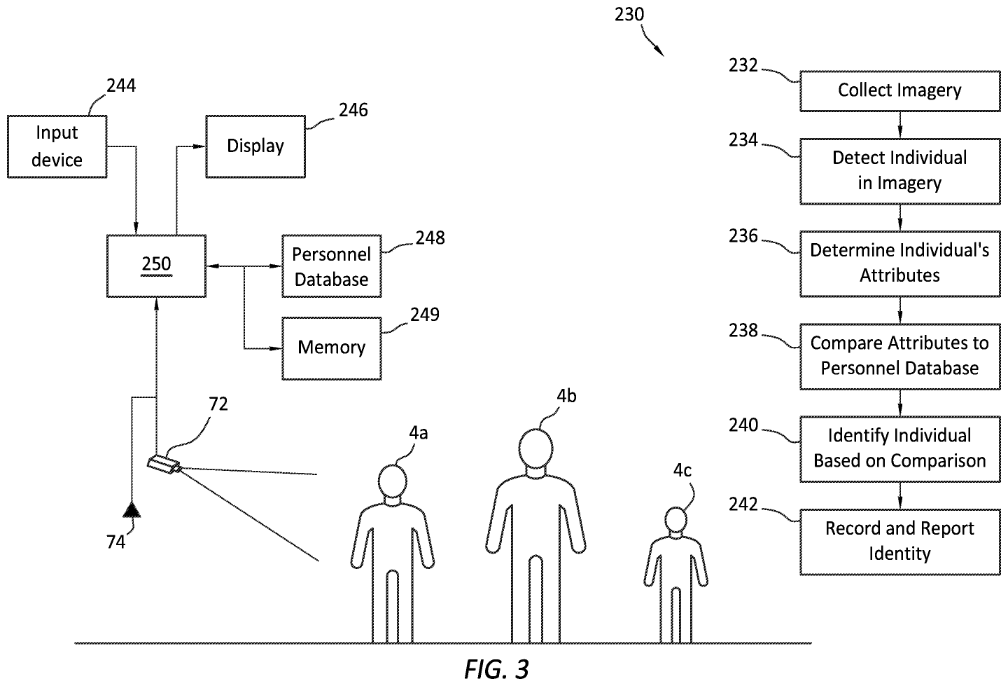

Examples of local data sources are shown in FIG. 1A where an imaging system can include the rig controller 250 and imaging sensors 72 positioned at desired locations around the rig and around support equipment/material areas, such as mud pumps (see FIG. 2), horizontal storage area 56, power system 26, etc. to collect imagery of the desired locations. Also, various sensors 74 can be positioned at various locations around the rig 10 and the support equipment/material areas to collect information from the rig equipment (e.g., pipe handler 30, roughneck 38, top drive 18, vertical storage 36, etc.) and support equipment (e.g., crane 46, forklift 48, horizontal storage area 56, power system 26, etc.) to collect operational parameters of the equipment. Additional information can be collected from other data sources, such as reports and logs 28 (e.g., tour reports, daily progress reports, reports from remote locations, shipment logs, delivery logs, personnel logs, etc.).

These data sources can be aggregated by the rig controller 250 and used to determine an estimated well activity of the rig and comparing it to the digital well plan to determine the progress and performance of the rig 10 in executing the digital well plan. The data collected from the data sources can be used to calculate the estimated well activity of the rig along with a confidence level that can indicate a level of confidence that the estimated well activity is the actual well activity being performed by the rig. A low confidence level may indicate that there is a low probability that the estimated well activity is the actual well activity being performed by the rig, and a high confidence level may indicate that there is a high probability that the estimated well activity is the actual well activity being performed by the rig. With the confidence level determined and the estimated well activity determined, the rig controller 250 can compare the estimated well activity to the expected well activity (which can be defined by the digital well plan) and determine if the estimated well activity is a planned or unplanned well activity.

As used herein, a “planned well activity” refers to when the estimated well activity directly correlates to the expected well activity of the digital well plan and the estimated well activity has a confidence level above a predetermined value that indicates a high probability that the estimated well activity is the actual well activity. As used herein, an “unplanned well activity” refers to when the estimated well activity does not correlate to the expected well activity of the digital well plan and the estimated well activity has a confidence level above a predetermined value that indicates a high probability that the estimated well activity is not the actual current well activity.

The data sources can also include wearables 70 (e.g., a smart wristwatch, a smartphone, a tablet, a laptop, an identification badge, a wearable transmitter, etc.) that can be worn by an individual 4 (or user 4) to identify the individual 4, deliver instructions to the individual 4, or receive inputs from the individual 4 via the wearable 70 to the rig controller 250 (see FIG. 1B). Network connections (wired or wireless) to the wearables 70 can be used for communication between the rig controller 250 and the wearables 70 for information transfer.

FIG. 2 is a representative partial cross-sectional view of a rig 10 being used to drill a wellbore 15 in an earthen formation 8. FIG. 2 shows a land-based rig, but the principles of this disclosure can equally apply to off-shore rigs, as well. The rig 10 can include a top drive 18 with a traveling block 19 used to raise or lower the top drive 18. A derrick 14 extending from the rig floor, can provide the structural support of the rig equipment for performing subterranean operations (e.g., drilling, treating, completing, producing, testing, etc.). The rig can be used to extend a wellbore 15 through the earthen formation 8 by using a drill string 58 having a Bottom Hole Assembly (BHA) 60 at its lower end. The BHA 60 can include a drill bit 68 and multiple drill collars 62, with one or more of the drill collars including instrumentation 64 for LWD and MWD operations. During drilling operations, drilling mud can be pumped from the surface 6 into the drill string 58 (e.g., via pumps 84 supplying mud to the top drive 18) to cool and lubricate the drill bit 68 and to transport cuttings to the surface via an annulus 17 between the drill string 58 and the wellbore 15.

The returned mud can be directed to the mud pit 88 through the flow line 81 and the shaker 80. A fluid treatment 82 can inject additives as desired to the mud to condition the mud appropriately for the current well activities and possibly future well activities as the mud is being pumped to the mud pit 88. The pump 84 can pull mud from the mud pit 88 and drive it to the top drive 18 to continue circulation of the mud through the drill string 58.

Sensors 74 and imaging sensors 72 can be distributed about the rig and downhole to provide information on the environments in these areas as well as operating conditions, health of equipment, well activity of equipment, fluid properties, WOB, ROP, RPM of the drill string, RPM of the drill bit 68, hook load, pump pressure, stand-pipe pressure, etc.

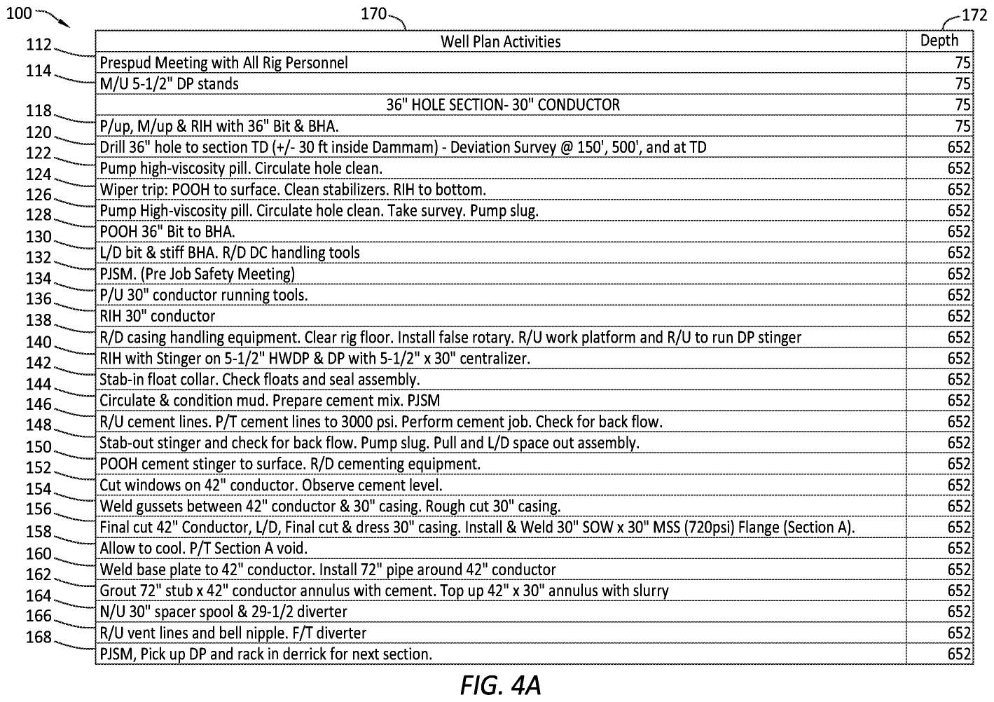

FIG. 3 is a representative front view of various users 4a, 4b, 4c that can be detectable via an imaging system. The imaging system can include the rig controller 250 and one or more imaging sensors 72. When determining the current well activity, it can be beneficial to detect how many individuals are present on the rig, where they are, who they are, and what they are doing. For example, one or more imaging sensors 72 can be used to detect individuals on the rig, track their location as they move about the rig, and determine the identity of each of the individuals. By receiving imagery from the one or more imaging sensors 72, the rig controller 250 can perform image recognition to detect the individuals (such as individuals 4a, 4b, 4c) in the imagery. The rig controller 250 can also determine where each of the individuals are on the rig based on identification of the surroundings around the individuals in the imagery. The rig controller 250 can also determine the identity of each individual by determining attributes of the individual 4, where the attributes can include physical characteristics, mannerisms, walking motion, and voice (e.g., via audio sensors included in the imaging sensors). The collected data can then be compared against a personnel database 248 to determine the unique identity of each individual 4. The rig controller 250 can record, report, or display the individual's 4 identity. An input device 244 can be used to provide input to the rig controller 250, such as to request identity verification or determination of an individual 4.

The method 230 illustrates a representative flow diagram for using the rig controller 250 to determine an identity of an individual 4 at the rig site. At operation 232, the rig controller 250 can autonomously (or as a result of a user request) collect imagery or other sensor data of one or more individuals 4 at the rig site via the imaging sensor(s) 72 or other sensors 74. At operation 234, the rig controller 250 can detect the one or more individuals in the imagery or sensor data. In operation 236, the rig controller 250 can analyze the imagery or sensor data to determine the attributes of the individual 4. In operation 238, the rig controller 250 can compare the determined attributes to attributes in a personnel database 248. In operation 240, rig controller 250 can identify the individual 4 based on the comparison of the attributes. In operation 242, rig controller 250 can record the individual's identity and report the identity to interested users. With the identity of each of the individuals determined, the rig controller 250 can compare the actual individuals with the well plan and can use the comparison to improve the confidence level of the estimated well activity.

After determining the unique identity of each individual 4, the rig controller 250 can determine the expertise/skills and experience level of the individual such as from a lookup table stored in non-transitory memory 249 which can be communicatively coupled to the rig controller 250. By knowing the unique identity of the individual, their skill set, and their location on the rig or in support areas, the rig controller 250 can assimilate this information along with the data from other various data sources to better determine the estimated well activity. If the estimated well activity is an expected well activity when compared to the digital well plan, then expected progress is being made in executing the digital well plan.

The who and where information of each individual 4 supporting the rig 10 can also be used to verify that the secondary operations are being performed in a timely manner so they do not become a primary activity. As used herein “primary activities” are those activities that are listed in the digital well plan, and as used herein “secondary operations” are those operations that provide support for the execution of the primary activities. Secondary operations can become primary activities if they do not adequately support the primary activities and cause delays in the primary activities by not being able to properly execute the primary activities.

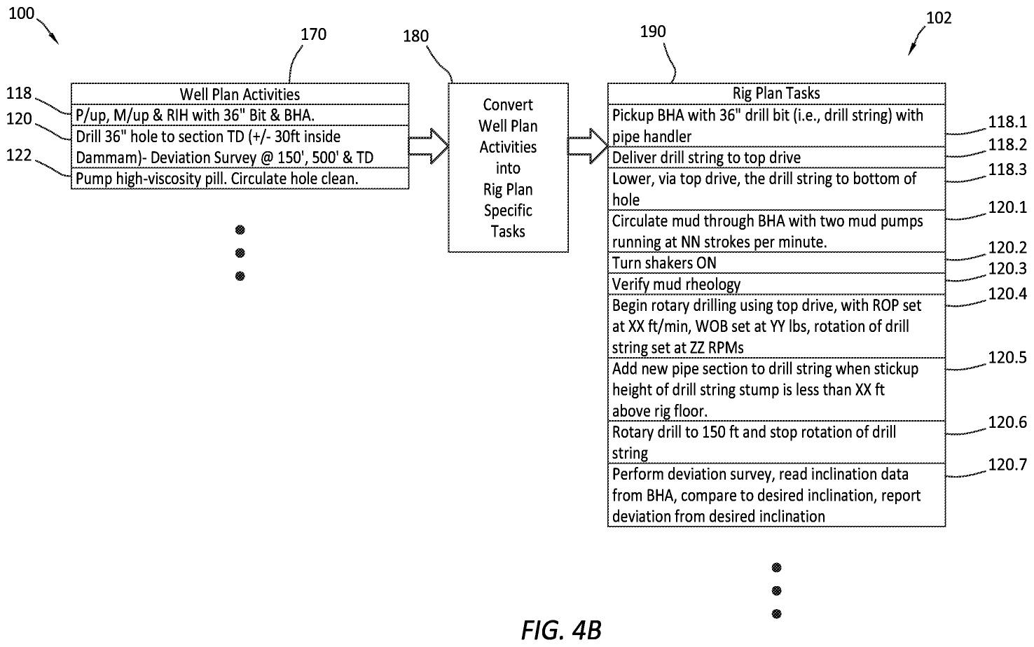

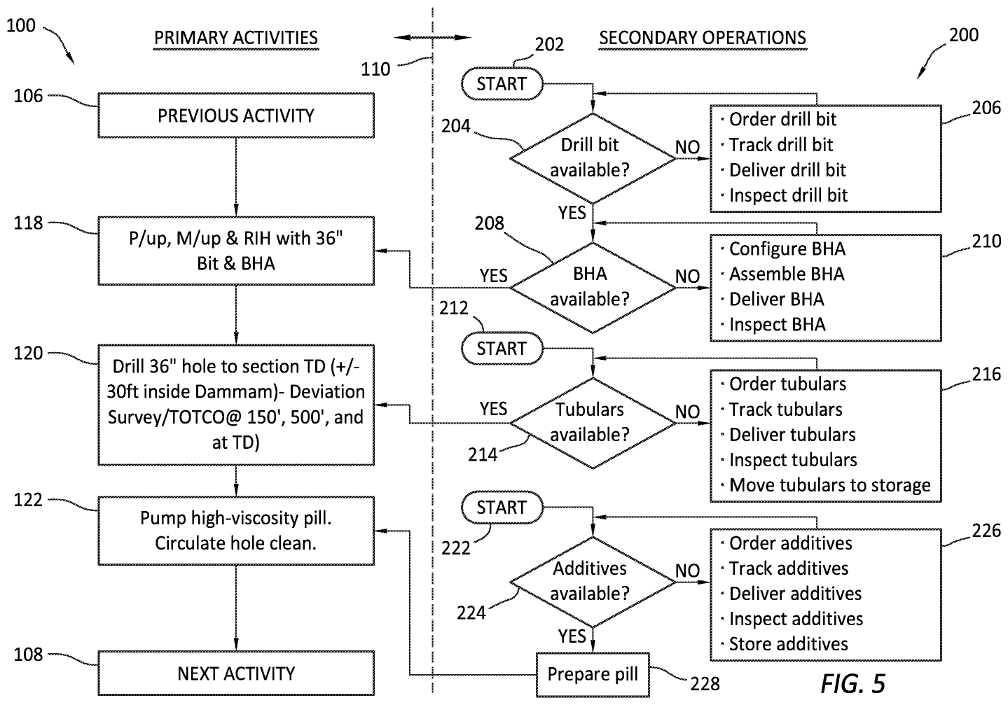

FIG. 4A is a representative list of well plan activities 170 for an example digital well plan 100. This list of well plan activities 170 can represent the activities needed to execute a full digital well plan 100. However, in FIG. 4A the list of activities 170 is merely representative a subset of a complete list of activities needed to execute a full digital well plan 100 to drill and complete a wellbore 15 to a target depth (TD). The digital well plan 100 can include well plan activities 170 with corresponding wellbore depths 172. However, these activities 170 are not required for the digital well plan 100. More or fewer activities 170 can be included in the digital well plan 100 in keeping with the principles of this disclosure. Therefore, the following discussion relating to the well plan activities 170 is merely an example to illustrate the concepts of this disclosure.

After the rig 10 has been utilized to drill the wellbore 15 to a depth of 75, at activity 112, a Prespud meeting can be held to brief all rig personnel on the goals of the digital well plan 100.

At activity 114, the appropriate personnel and rig equipment can be used to make-up (M/U) 5½″ drill pipe (DP) stands in prep for the upcoming drilling operation. This can for example require a pipe handler, horizontal or vertical storage areas for tubular segments, or tubular stands. The primary activities can be seen as the make-up of the drill pipe (DP) stands, with the secondary operations being, for example, availability of tubular segments to build the DP stands; availability of a pipe handler (e.g., pipe handler 30) to manipulate the tubulars; a torquing wrench and backup tong for torquing joints when assembling the DP stands in a mousehole, a horizontal storage area, or a vertical storage area; available space in a storage area for the DP stands; doping compound and doping device available for cleaning and doping threads of the tubulars 50; appropriate personnel to support these operations.

At activity 118, the appropriate personnel and rig equipment can be used to pick up (P/up), makeup (M/up), and run-in hole (RIH) a BHA with a 36″ drill bit 68. This can, for example, require BHA components; a pipe handler to assist in the assembly of the BHA components; a pipe handler to deliver BHA to a top drive; and lowering the top drive to run the BHA into the wellbore 15. The primary activities can be seen as assembling the BHA and lowering the BHA into the wellbore 15. The secondary operations can be delivering the BHA components, including the drill bit, to the rig site; monitoring the health of the equipment to be used; and ensuring personnel available to perform tasks when needed.

At activity 120, the appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). The primary activities can be seen as repeatedly feeding tubulars (or tubular stands 54) via a pipe handler to the well center from a tubular storage for connection to a tubular string 58 in the wellbore 15; operating the top drive 18, the iron roughneck 38, and slips 92 to connect tubulars 50 (or tubular stands 54) to the tubular string 58; cleaning and doping threads of the tubulars 50, 54; running mud pumps to circulate mud through the tubular string 58 to the bit 68 and back up the annulus 17 to the surface; running shakers; injecting mud additives to condition the mud; rotating the tubular string 58 or a mud motor (not shown) to drive the drill bit 68, and performing deviation surveys at the desired depths.

The secondary operations can be seen as having tubulars 50 (or tubular stands 54) available in the horizontal storage or vertical storage locations and accessible via the pipe handler. If coming from the horizontal storage 56, then the tubulars 50 can be positioned on horizontal stands, with individuals 4 operating handling equipment, such as forklifts 48 or crane 46, to keep the storage area 56 stocked with the tubulars 50. If coming from the vertical storage 36, then the rig personnel 4, can make sure that enough tubular stands 54 (or tubulars 50) are racked in the vertical storage 36 and accessible to the pipe handler 30 (or another pipe handler if needed). Additional secondary operations can be seen as ensuring that the doping compound and doping device are available for cleaning and doping threads of the tubulars 50; mud additives are available for an individual 4 (e.g., mud engineer) or an automated process to condition the mud as needed; the top drive 18 (including drawworks), iron roughneck 38, slips, and pipe handlers are operational; and ensuring the power system 26 is configured to support the drilling operation.

At activity 122, the appropriate personnel and rig equipment can be used to pump a high-viscosity pill through the wellbore 15 via the tubular string 58 and then circulate wellbore 15 clean. The primary activities can be seen as injecting mud additives into the mud to create the high-viscosity pill, mud pumps operating to circulate the pill through the wellbore 15 (down through the tubular string 58 and up through the annulus 17); slips to hold tubular string 58 in place; top drive 18 connected to tubular string 58 to circulate mud; and, after pill is circulated, circulating mud through the wellbore 15 to clean the wellbore 15. The secondary operations can be ensuring the power system 26 is configured to support the mud circulation activities; the mud pumps 84 are configured to supply the desired pressure and flow rate of fluid to the tubular string 58; and that the mud additives are available for an individual 4 (e.g., mud engineer) or an automated process to condition the mud as needed.

At activity 124, the appropriate personnel and rig equipment can be used to perform a “wiper trip” by pulling the tubular string 58 out of the hole (Pull out of hole—POOH) to the surface 6; clean stabilizers on the tubular string 58; and run the tubular string 58 back into the hole (Run in hole—RIH) to the bottom of the wellbore 15. The primary activities can be seen as operating the top drive 18, the iron roughneck 38, and slips to disconnect tubulars 50 (or tubular stands 54) from the tubular string 58; moving the tubulars 50 (or tubular stands 54) to vertical storage 36 or horizontal storage 56 via a pipe handler, equipment and personnel 4 to clean the stabilizers; and operating the top drive 18, the iron roughneck 38, and slips to again connect tubulars 50 (or tubular stands 54) to the tubular string 58; and run the tubular string 58 back into the wellbore 15.

The secondary operations can be seen as having the top drive 18 (including drawworks), iron roughneck 38, slips, and pipe handlers operational; ensuring the power system 26 is configured to support the tripping out and tripping in operations; and ensuring that the appropriate individual(s) 4 and cleaning equipment are available to perform stabilizer cleaning when needed.

At activities 126 thru 168, the appropriate personnel and rig equipment can be used to perform the indicated well plan activities. The primary activities can include the personnel, equipment, or materials needed to directly execute the well plan activities using the specific rig 10. The secondary operations can be those activities that ensure the personnel, equipment, or materials are available and configured to support the primary activities.

FIG. 4B is a functional diagram that can illustrate the conversion of well plan activities 170 to rig plan tasks 190 of a rig specific digital rig plan 102. When a well plan 100 is designed, well plan activities 170 can be included to describe primary activities needed to construct a desired wellbore 15 to a TD. However, the well plan 100 activities 170 are not specific to a particular rig, such as rig 10. It may not be appropriate to use the well plan activities 170 to direct specific operations on a specific rig, such as rig 10. Therefore, a conversion of the well plan activities 170 can be performed to create a list of rig plan tasks 190 of a digital rig plan 102 to construct the desired wellbore 15 using a specific rig, such as rig 10. This conversion engine 180 (which can run on a computing system such as the rig controller 250) can take the non-rig specific well plan activities 170 as an input and convert each of the non-rig specific well plan activities 170 to a series of rig specific tasks 190 to create a digital rig plan 102 that can be used to direct tasks on a specific rig, such as rig 10, to construct the desired wellbore 15.

As way of example, a high-level description of the conversion engine 180 will be described for a subset of well plan activities 170 to demonstrate a conversion process to create the digital rig plan 102. The well plan activity 118 states, in abbreviated form, to pick up, make up, and run-in hole a BHA 60 with a 36″ drill bit. The conversion engine 180 can convert this single non-rig specific activity 118 into, for example, three rig-specific tasks 118.1, 118.2, 118.3. Task 118.1 can instruct the rig operators or rig controller 250 to pickup the BHA 60 (which has been outfitted with a 36″ drill bit) with a pipe handler. At task 118.2, the pipe handler can carry the BHA 60 and deliver it to the top drive 18, with the top drive 18 using an elevator to grasp and lift the BHA 60 into a vertical position. At task 118.3, the top drive 18 can lower the BHA 60 into the wellbore 15 which has already been drilled to a depth of 75′ for this example as seen in FIG. 4A. The top drive 18 can lower the BHA 60 to the bottom of the wellbore 15 to have the drill bit 68 in position to begin drilling as indicated in the following well activity 120.

The well plan activity 120 states, in abbreviated form, to drill a 36″ hole to a target depth (TD) of the section, such as 652 ft, to +/−30 ft inside a known formation layer (e.g., Dammam), and performing a deviation survey at depths of 150′, 500′ and TD (i.e., 652′ in this example). The conversion engine 180 can convert this single non-rig specific activity 120 into, for example, seven rig-specific tasks 120.1 to 120.7. Task 120.1 can instruct the rig operators or rig controller 250 to circulate mud through the top drive 18, through the drill string 58, through the BHA 60, and exiting the drill string 58 through the drill bit 68 into the annulus 17. For this example, the mud flow requires two mud pumps 84 to operate at “NN” strokes per minute, where “NN” is a desired value that delivers the desired mud flow and pressure. At task 120.2, the shaker tables can be turned on in preparation for cuttings that should be coming out of the annulus 17 when the drilling begins. At task 120.3, a mud engineer can verify that the mud characteristics are appropriate for the current tasks of drilling the wellbore 15. If the rheology indicates that mud characteristics should be adjusted, then additives can be added to adjust the mud characteristics as needed.

At task 120.4, rotary drilling can begin by lowering the drill bit into contact with the bottom of the wellbore 15, and rotating the drill bit by rotating the top drive 18 (e.g., rotary drilling). The drilling parameters can be set to be “XX” ft/min for rate of penetration (ROP), “YY” lbs for weight on bit (WOB), and “ZZ” revolutions per minute (RPM) of the drill bit 68.

At task 120.5, as the wellbore 15 is extended by the rotary drilling, when the top end of the tubular string 58 is less than “XX” ft above the rig floor 16, then a new tubular segment (e.g., tubular, tubular stand, etc.) can be added to the tubular string 58 by retrieving a tubular segment 50, 54 from tubular storage via a pipe handler, stop mud flow and disconnect the top drive from the tubular string 58, hold the tubular string 58 in place via the slips at well center, raise the top drive 18 to provide clearance for the tubular segment to be added, transfer tubular segment 50, 54 from the pipe handler 30 to the top drive 18, connect the tubular segment 50, 54 to the top drive 18, lower the tubular segment 50, 54 to the stump of the tubular string 58 and connect it to the tubular string 58 using a roughneck to torque the connection, then start mud flow. This can be performed each time the top end of the tubular string 58 is lowered below “XX” ft above the rig floor 16.

At task 120.6, add tubular segments 50, 54 to the tubular string 58 as needed in task 120.5 to drill wellbore 15 to a depth of 150 ft. Stop rotation of the drill bit 68 and stop mud pumps 84.

At task 120.7, perform a deviation survey by reading the inclination data from the BHA 60, comparing the inclination data to expected inclination data, and report deviations from the expected. Correct drilling parameters if deviations are greater than a pre-determined limit.

The conversion from a well plan 100 to a rig-specific rig plan 102 can be performed manually or automatically with the best practices and equipment recipes known for the rig that is to be used in the wellbore construction.

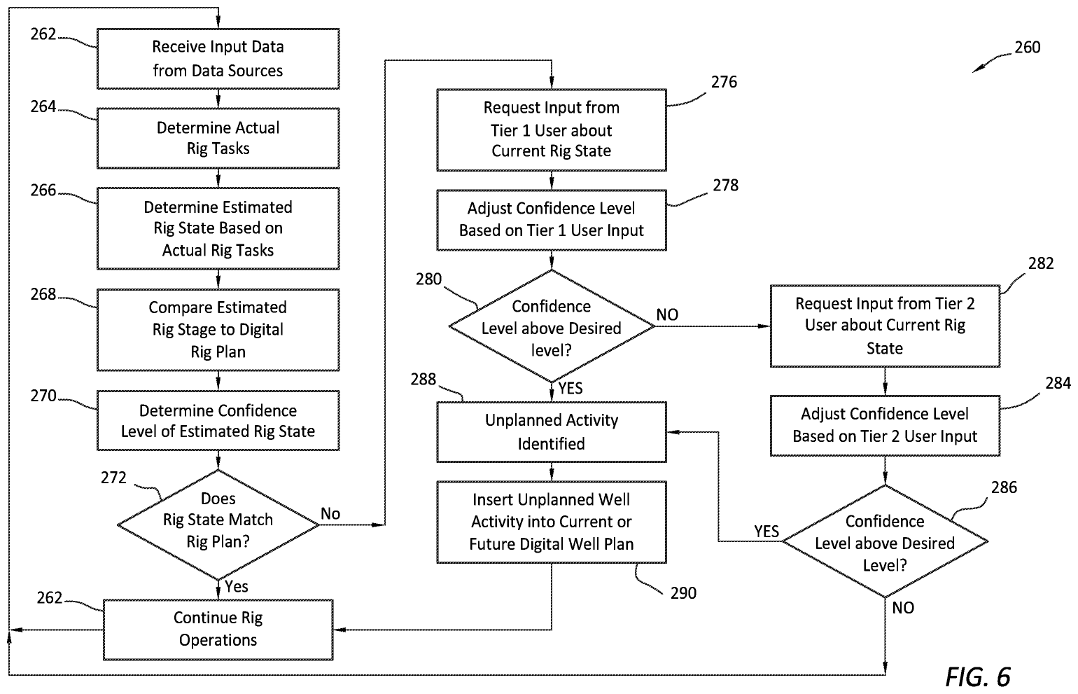

FIG. 5 is a flow diagram that shows secondary operations occurring at the same time, or at least in parallel, with primary activities, where the secondary operations are tasks that support the execution of the primary activities. Delays in the execution of the primary activities can have a direct impact on the completion of the well plan in the desired amount of time. Secondary operations should not directly impact the completion of the well plan unless they cause delays in the primary activities. If a secondary operation directly impacts a primary activity, then the secondary operation can become a primary activity, since its completion directly impacts well plan completion deadlines.

FIG. 5 shows primary activities that can be executed in sequence as the well plan is executed on the rig 10. After completion of a previous activity 106, the rig can proceed to the activity 118. The appropriate personnel and rig equipment can be used to pick up (P/up), makeup (M/up), and run-in hole (RIH) a BHA with a 36″ drill bit 68. However, there can be secondary operations 200 that may need to be performed simultaneously with the previous activity 106 or before the previous activity 106 such that the activity 118 can be performed without delay when the previous activity 106 (for example, activity 114 for making up 5½″ DP stands) is completed.

The secondary operations 200 are shown on the right side of the primary/secondary dividing line 110 that symbolically separates the primary activities (shown on the left of the line 110) from the secondary operations. This separation can be maintained as long as the secondary operations do not become primary activities by delaying execution of a primary activity by a delayed completion of the secondary operation.

Regarding the primary activity 118, the BHA components should be available well before they are needed in the primary activity 118. Therefore, secondary operations (e.g., operations 202, 204, 206, 208, 210) should be performed in parallel or prior to the previous activity 106 so that when the previous activity 106 is complete and it is time to execute the activity 118, the BHA 60 is ready to be run-in the hole. Therefore, as way of example, the secondary operations to prepare the BHA 60 for activity 118, in which it is to be used, can start the secondary operations at the operation 202. At operation 204, it is determined whether the desired drill bit 68 (e.g., 36″ drill bit in this example) is available for assembly onto the BHA drill collars, if not an appropriate drill bit can be ordered, shipment tracked, delivered to the rig or rig site, and inspected at operation 206. Operation 206 can deliver the newly acquired drill bit 68 to a BHA assembly area for attachment to the BHA drill collars. With the drill bit available, the secondary operations can proceed to operation 208 to determine if the BHA is available for use in the activity 118. If not, then operation 210 can be performed to assemble the BHA components together, inspect the BHA and deliver the BHA to a BHA storage area. When the rig is ready to execute the activity 118, then a pipe hander 30 can deliver the BHA to well center, hand it off to the top drive 18, which can then lower the BHA into the wellbore 15.

If the secondary operations are not performed in time to have the BHA available when the activity 118 begins, then the secondary operations can be directly impacting execution times of the primary activities and thereby become primary activities themselves.

Similarly, after completion of the activity 118, the rig can proceed to the activity 120. The appropriate personnel and rig equipment can be used to drill 36″ hole to a TD of the section, such as 652 ft, to +/−30 ft inside a known formation layer (e.g., Dammam), and performing a deviation survey at depths of 150′, 500′ and TD (i.e., 652′ in this example). However, there can be secondary operations 200 that may need to be performed simultaneously with the activity 118 or before the activity 118 such that the activity 120 can be performed without delay when the activity 118 is complete.

Regarding activity 120, the primary activities can be seen as repeatedly feeding tubulars (or tubular stands 54) via a pipe handler 30 from a tubular storage for connection to a tubular string 58 to the well center; operating the top drive 18, the iron roughneck 38, and slips to connect tubulars 50 (or tubular stands 54) to the tubular string 58; cleaning and doping threads of the tubulars 50, 54; running mud pumps to circulate mud through the tubular string 58 to the bit 68 and back up the annulus 17 to the surface; running shakers; injecting mud additives to condition the mud; rotating the tubular string 58 or a mud motor (not shown) to drive the drill bit 68, and performing deviation surveys at the desired depths.

The secondary operations 200 can be seen as having tubulars 50 (or tubular stands 54) available in the horizontal storage or vertical storage locations and accessible via the pipe handler 30. If coming from the horizontal storage 56, then the tubulars 50 can be positioned on horizontal stands, with individuals 4 operating handling equipment, such as forklifts 48 or crane 46, to keep the storage area 56 stocked with the tubulars 50. If coming from the vertical storage 36, then the rig personnel 4, can make sure that enough tubular stands 54 (or tubulars 50) are racked in the vertical storage 36 and accessible to the pipe handler 30 (or another pipe handler if needed). Additional secondary operations can be seen as ensuring that the doping compound and doping device are available for cleaning and doping threads of the tubulars 50; mud additives are available for an individual 4 (e.g., mud engineer) or an automated process to condition the mud as needed; the top drive 18 (including drawworks), iron roughneck 38, slips, and pipe handlers are operational; and ensuring the power system 26 is configured to support the drilling operation.

As way of example, as shown in FIG. 5, some secondary operations can be to have the necessary tubulars 50, 54 available in a storage area accessible by the top drive or pipe handler so execution of the primary activity 120 can begin as soon as the activity 118 is completed. The secondary operations 212, 214, 216 for providing tubulars for activity 120 can start at the operation 212. At operation 214, it can be determined whether the tubulars 50, 54 are available for extending the tubular string 58 into the wellbore 15 as activity 120 progresses to completion. If not available, or not enough available, appropriate tubulars can be ordered, shipment tracked, delivered to the rig or rig site, inspected, and moved to storage areas accessible to the top drive 18 or pipe handler 30 at operation 216.

If tubular stands 54 are needed, then the secondary operations 200 can include an operation of building tubular stands 54 from the tubulars 50. In this particular example, the secondary operations 212, 214, 216 can be performed simultaneously while the primary activity 120 is being performed. The secondary operations 212, 214, 216 need only provide enough tubulars 50, 54 to the tubular storage areas to support when the rig requires the next tubular 50, 54 to be added to the tubular string 58. Therefore, tubulars 50, 54 can be delivered to the storage areas during the time the tubulars are being removed from the storage area to be added to the tubular string 58. The secondary operations 200 do not become primary activities until the top drive 18 or pipe hander 30 cannot retrieve a tubular 50, 54 from the storage to continue the primary activity 120. However, the tubulars 50, 54 can also be delivered and installed in the storage area prior to the beginning of the activity 120.

Another secondary operation that can occur pertains to replacing damaged or otherwise unusable tubulars 50, 54 with useable tubulars 50, 54 before the rig runs out of available tubulars 50, 54 to support the activity 120.

At primary activity 122, the appropriate personnel and rig equipment can be used to pump a high-viscosity pill through the wellbore 15 via the tubular string 58 and then circulate wellbore 15 clean. The primary activities can be seen as injecting mud additives into the mud to create the high-viscosity pill, mud pumps operating to circulate the pill through the wellbore 15 (down through the tubular string 58 and up through the annulus 17); slips to hold tubular string 58 in place; top drive 18 connected to tubular string 58 to circulate mud; and, after pill is circulated, circulating mud through the wellbore 15 to clean the wellbore 15.

The secondary operations 200 can ensure the power system 26 is configured to support the mud circulation activities; the mud pumps 84 are configured to supply the desired pressure and flow rate of fluid to the tubular string 58; and that the mud additives are available for an individual 4 (e.g., mud engineer) or an automated process to condition the mud as needed.

As way of example, as shown in FIG. 5, some secondary operations 200 can be to have the necessary additives available and accessible to a mud engineer to condition the mud as needed to prepare the pill at operation 228 prior to completion of the primary activity 120 so execution of the primary activity 122 can begin on time. The secondary operations 222, 224, 226, 228 for providing the additives and preparing the pill can start at the operation 222. At operation 224, it can be determined whether the additives are available for conditioning the mud. If not available, additives can be ordered, shipment tracked, delivered to the rig or rig site, inspected, and moved to storage for access by the mud engineer or automated process to prepare the pill in operations 228.

It should be understood that these secondary operations 200 can be a subset of the available secondary operations. Many more secondary operations can be required to support the primary activities throughout the execution of the well plan 100 on the rig 10. However, the secondary operations 200 described here can illustrate the interaction between primary activities and secondary operations for executing a well plan 100.

The data sources available to the rig controller 250 can be used to monitor and verify if the secondary operations 200 are being performed in a timely manner to support the particular primary activities 170. Therefore, if the rig controller 250 identifies a secondary operation 200 that is not being completed in time to support upcoming primary activities 170, the rig controller 250 can alert an appropriate individual 4 (e.g., driller, roughneck, operator, company man, mud engineer, etc.) to implement corrective actions to get the appropriate secondary operations 200 completed in time to support the primary activities 170. The rig controller 250 can also act autonomously to initiate corrective actions to correct execution of the secondary operations 200 to minimize or prevent the secondary operations 200 from impacting the execution of the primary activities 170. For example, the rig controller 250 can initiate expedited orders of material to be delivered, turn on other equipment if current equipment is not functioning or otherwise not available, request additional personnel to assist in the execution of the operations 200, etc.

The rig controller 250 can monitor the secondary operations 200 and automatically create and communicate periodic reports to individual(s) 4 or other controllers to inform the individuals or other controllers of the status of the secondary operations 200, and highlight areas of concern related to the timely execution of the secondary operations 200 and identify any of the secondary operations 200 that may impact execution of the primary activities 170. The rig controller 250 can analyze the secondary operations 200 being performed at the rig site and compare them to the digital well plan 100. If more or fewer secondary operations 200 are being performed than indicated by the digital rig plan that is implementing the digital well plan 100, then the rig controller 250 can alert individuals 4 to the mismatch and initiate corrective actions (either automatically, semi-automatically after requesting and receiving user input, or manually via user input) based on the mismatch identified during the comparing.

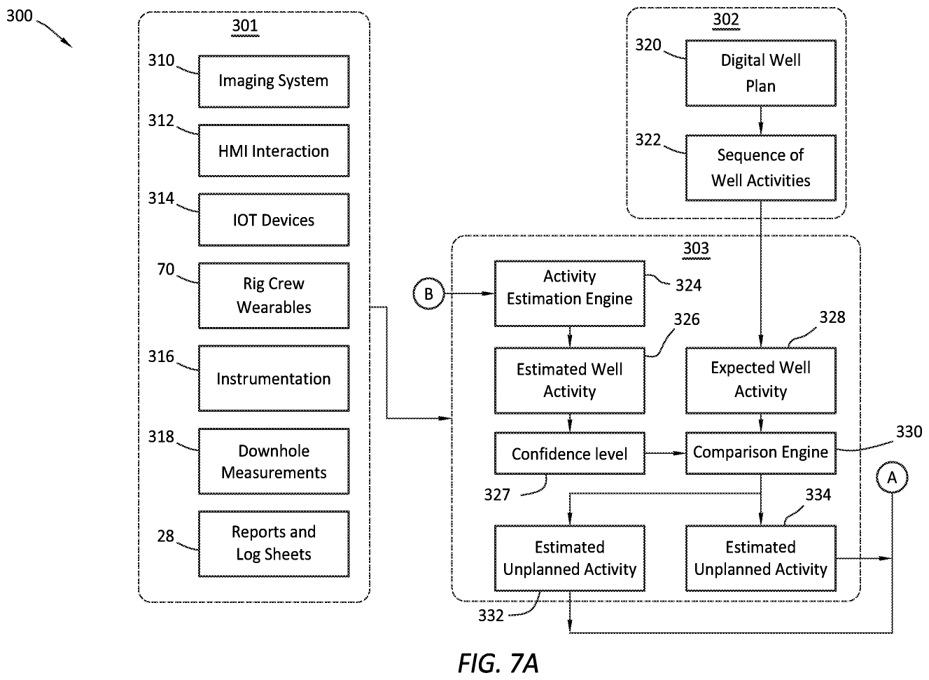

FIG. 6 is a functional block diagram of a method 260 for identifying an estimated well activity and determining a confidence level for the estimated well activity. The method 260 can include operation 262 where data can be received at the rig controller 250 from one or more data sources. By aggregating data from these sources, the rig controller 250 can determine actual rig tasks being performed on the rig in operation 264. In operation 266, the rig controller 250 can determine an estimated well activity based on the determined actual rig tasks. In operation 268, the rig controller 250 can compare the estimated well activity with an expected well activity of the digital well plan. In operation 270, the rig controller 250 can determine a confidence level in the accuracy of the estimated well activity being the actual well activity.

As used herein, a “tier 1 user” refers to an individual 4 that is a resident expert in the particular operations being performed. For example, during drilling, a tier 1 user can be a driller, a company man for a drilling company, or a contractor with expertise in the field of drilling. For example, during wellbore cleaning, a tier 1 user can be a driller, a mud engineer, or a worker or contractor with expertise in the field of wellbore cleaning, mud circulation, or mud rheology.

As used herein, a “tier 2 user” refers to an individual 4 that is an experienced worker involved in operating, controlling, or monitoring equipment in support of the particular operation being performed. For example, during drilling, a tier 2 user can be a roughneck, equipment operator of equipment used in the operation, or a worker or contractor with knowledge and experience in the field. For example, during wellbore cleaning, a tier 2 user can be a mud pump operator, a mud engineer apprentice, or a worker or contractor with experience in the field of wellbore cleaning, mud circulation, or mud rheology.

In operation 272, based on the confidence level and the comparison of the estimated well activity to the expected well activity, the rig controller 250 can determine if the estimated well activity accurately represents the expected well activity of the digital well plan. If not, the rig controller 250 can request input from a tier 1 user in operation 276 and adjust the confidence level in operation 278 in response to the input from the tier 1 user. It should be understood that the rig controller 250 can also request input from a tier 2 user and adjust the confidence level in response to the input from the tier 2 user. It is not required to request input from a tier 1 user before requesting input from a tier 2 user. If the confidence level is still below a desired level, as determined in operation 280, the rig controller 250 can request input from a tier 2 user in operation 282 and adjust the confidence level in operation 284 in response to the input from the tier 2 user. If the confidence level is still below a desired level, as determined in operation 286, then the rig controller 250 can return to operation 262 to begin the process again.

If the confidence level is determined to be equal to or greater than the desired level in operation 280, the rig controller 250 can identify the estimated well activity as an unplanned activity in operation 288, since the confidence level is above the desired level (high confidence) and the well activity does not agree with the expected well activity. In operation 290, the rig controller 250 can insert or include the unplanned well activity into a future digital well plan for drilling a future wellbore or the rig controller 250 can insert the unplanned well activity into the current digital well plan for managing future unplanned activities while drilling the current wellbore 15. The rig controller 250 can automatically include the unplanned well activity in a well plan report. In operation 274, the rig controller 250 can continue rig operations by returning to operation 262 and repeating the operations of method 260.

If the confidence level is determined to be equal to or greater than the desired level in operation 286, the rig controller 250 can identify the estimated well activity as an unplanned activity in operation 288, since the confidence level is above the desired level (high confidence) and the well activity does not agree with the expected well activity according to the well plan 100. In operation 290, the rig controller 250 can insert or include the unplanned well activity into a future digital well plan for drilling a future wellbore or the rig controller 250 an insert the unplanned well activity into the current digital well plan for managing future unplanned activities while drilling the current wellbore 15. The rig controller 250 can automatically include the unplanned well activity in a well plan report. In operation 274, the rig controller 250 can continue rig operations by returning to operation 262 and repeating the operations of method 260.

The unplanned well activity can be used to train a machine learning processor MLP (which can be a processor of the rig controller 250) so that future results from the MLP can incorporate the unplanned activity in a future well plan as a planned activity, thereby by improving future well plans when deviations in the current well plan are detected and handled. Therefore, a future well plan can be generated, based on execution of the current well plan, to include both planned and unplanned activities of the current well plan execution, such that the future well plan incorporates the unplanned activities of the current well plan execution as planned activities in the future well plan.

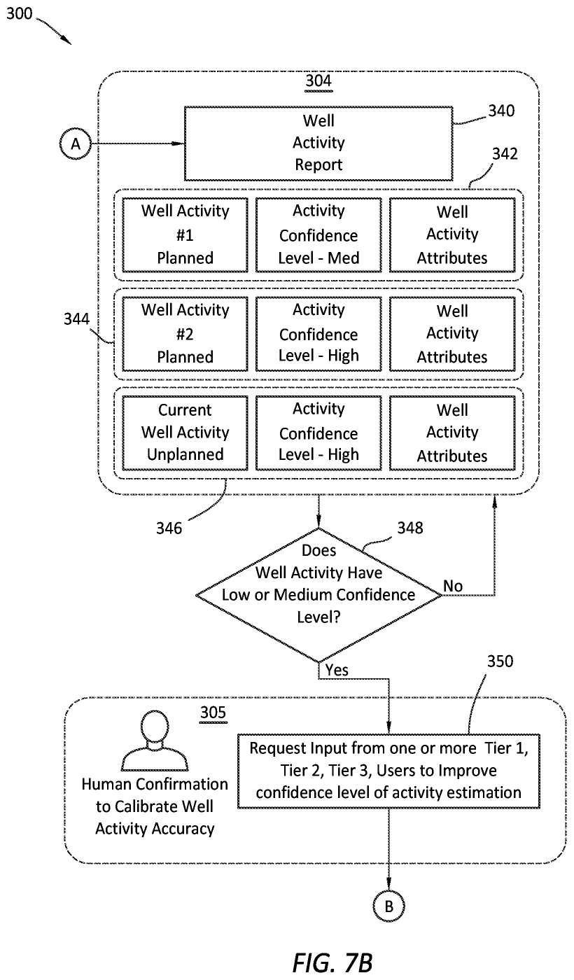

FIG. 7 is a flow diagram of a method 300 for determining the confidence level of an estimated well activity and detecting planned/unplanned well activities on a rig 10 when compared to a desired well plan 100. An activity estimator 303 can receive inputs from data sources 301 and from the well plan source 302. The activity estimator 303 can estimate a current well activity based on data from the data sources 301 and a confidence level in the accuracy of the estimated well activity. The activity estimator 303 can compare the estimated well activity to an expected well activity to determine if the estimated well activity is a planned or an unplanned well activity. The activity estimator 303 can send the confidence level, estimated well activity, and planned/unplanned indication to a reporting engine 304. The reporting engine 304 can receive, record, and report the confidence level, estimated well activity, and planned/unplanned indication for the current (estimated) well activity. The reporting engine 304 can report historical data for previous well activities which can be used to analyze the performance of the rig 10 for executing the well plan 100 on the rig 10. If the confidence level for the estimated well activity is low (i.e., below a predetermined value), then the reporting engine 304 can send this information to the human confirmation engine 305, which can request inputs from tier 1, tier 2, or tier 3 users to improve the confidence level of the estimated well activity. The user inputs can then be sent to the activity estimator 303 which can revise the confidence level and possibly the estimated well activity based on the user input.

Data sources 301 can include data regarding the rig, rig operations, rig equipment, rig personnel, historical data, or rig supplies. The data sources 301 can include an imaging system 310, human-machine interface (HMI) interaction 312, internet of things (IOT) devices 314, rig crew wearables 70, instrumentation 316 (including sensors 74), downhole measurements (including sensors 74) 318, or reports & log sheets 28.

The imaging system 310 can include imaging sensors 72 and the rig controller 250 for collecting and analyzing imagery from various locations around the rig and rig site. For example, the imaging system 310 can detect tubulars in storage areas, detect physical characteristics of the tubulars, detect individuals around the rig and rig site as well as possibly identifying each individual 4, detect cuttings volume received from drilling operations, positions of equipment and individuals 4 on the rig or rig site for collision avoidance and well activity determinations, detect equipment and individuals 4 movements during rig operations, inventory tools in tool storage locations, or environmental conditions.

The HMI interaction 312 can provide data on interactions with humans (e.g., operators, drillers, users, managers, rig hands, etc.) regarding rig operations and support tasks. These interactions can also include interactions of users with wearables 70. The IOT devices 314 can provide data from internet connected devices as well as general internet access. The rig crew wearables 70 can be used by individuals 4 to interact with other individuals 4 on the rig or off, interact with equipment to monitor or control the equipment or provide the location and operational information regarding the individual 4 wearing the wearable 70. The instrumentation 316 can include sensors 74 distributed around the rig and rig site to provide sensor data to the rig controller 250 regarding processes and operations associated with the rig 10, such as rig sensors, downhole sensors, BHA instrumentation, logging instrumentation, etc. The downhole measurements 318 can also include downhole sensors 74, BHA instrumentation, and logging instrumentation. The downhole measurements 318 can provide data on wellbore characteristics, earthen formation characteristics, mud rheology, drill bit inclination, etc. The reports and log sheets 28 can include tour reports, daily progress reports, reports from remote locations, shipment logs, delivery logs, personnel logs, etc.

The information from the data sources 301 can be aggregated together by an activity estimation engine 324 of the activity estimator 303 and analyzed to determine an estimated well activity 326 and a confidence level 327. The well plan source 302 can include a digital well plan 320 that can be arranged in a sequence of well activities 322. The activity estimator 303 can track the execution of the digital well plan 320 and determine which of the well activities 322 is the expected well activity 328. The comparison engine 330 can compare the expected well activity 328 to the estimated well activity 326 which can be weighted based on the confidence level 327. The comparison engine 330 can determine if the estimated well activity 326 is estimated to be an unplanned activity 332 or a planned activity 334.

This information can be sent to the reporting engine 304, which can record and report the information (or data). As illustrated in an example in FIG. 7, the reporting engine 304 recorded and displayed a well activity #1 (342) which was indicated as a planned activity, with a medium confidence level, and well activity attributes associated with the well activity #1 (342). The reporting engine 304 recorded and displayed a well activity #2 (344) which was indicated as a planned activity, with a high confidence level, and well activity attributes associated with the well activity #2 (344). The reporting engine 304 recorded and displayed a well activity #1 (342) which was indicated as a planned activity, with a medium confidence level, and well activity attributes associated with the well activity #1 (362). The reporting engine 304 recorded and displayed the current well activity 346 which is indicated as an unplanned activity, with a high confidence level, and well activity attributes associated with the current well activity 366.

A confidence level checker 348 can analyze the confidence level 327 of the current well activity 346 and determine if it is below a pre-determined value (e.g., low or medium confidence level). If not, then the confidence level checker 348 can continue to monitor confidence levels received by the reporting engine 304. If the confidence level is below a pre-determined value (e.g., low or medium confidence level), then the confidence level checker 348 can send a request to the human confirmation engine 305. If the user inputs cause the confidence level or estimated well activity to be changed, then this can be reported to the reporting engine 304 to update the records and reports.

### Various Embodiments

Embodiment 1. A method for performing subterranean operations, the method comprising: collecting sensor data from one or more data sources, wherein the sensor data is representative of conditions at a rig; based on the sensor data, determining actual rig tasks being performed at the rig; based on the actual rig tasks, determining an estimated well activity for the rig; comparing the actual rig tasks to expected rig tasks in a digital rig plan; based on the comparing, setting a confidence level for the estimated well activity, wherein the confidence level indicates a degree of confidence in an accuracy of the estimated well activity being an actual well activity; and comparing, via a rig controller, the estimated well activity to an expected well activity in a digital well plan.

Embodiment 2. The method of embodiment 1, further comprising requesting user input regarding the confidence level.

Embodiment 3. The method of embodiment 2, further comprising receiving the user input and adjusting the confidence level of the estimated well activity based on the user input.

Embodiment 4. The method of embodiment 2, further comprising; requesting the user input via a rig controller; receiving the user input from an input device; and adjusting the confidence level based on the user input.

Embodiment 5. The method of embodiment 4, altering the estimated well activity to indicate another well activity based on the user input when the confidence level is below a predetermined value.

Embodiment 6. The method of embodiment 1, wherein the confidence level is in a range from 1 to 100, with a confidence level of 1 being a lowest value of the confidence level and a confidence level of 100 being a highest value of the confidence level.

Embodiment 7. The method of embodiment 1, wherein the confidence level being above or equal to a predetermined value indicates a high level of confidence that the estimated well activity is the actual well activity.

Embodiment 8. The method of embodiment 7, wherein the estimated well activity is a planned well activity, and wherein the planned well activity is an expected well activity according to the digital well plan since the estimated well activity correlates with the expected well activity of the digital well plan.

Embodiment 9. The method of embodiment 1, wherein the confidence level being below a predetermined value indicates a low level of confidence that the estimated well activity is the actual well activity.

Embodiment 10. The method of embodiment 9, further comprising requesting user input regarding the confidence level.

Embodiment 11. The method of embodiment 10, wherein, based on the user input, the confidence level is adjusted to be above or equal to a predetermined value, wherein the estimated well activity is a planned well activity, and wherein the planned well activity is an expected well activity according to the digital well plan since the estimated well activity correlates with an expected well activity of the digital well plan.

Embodiment 12. The method of embodiment 1, wherein when the confidence level is above a predetermined value, thereby indicating a high level of confidence that the estimated well activity is an actual well activity.

Embodiment 13. The method of embodiment 12, further comprising: comparing the actual well activity to an expected well activity of the digital well plan; determining that the actual well activity is not the expected well activity of the digital well plan; and identifying the actual well activity as an unplanned well activity.

Embodiment 14. The method of embodiment 13, further comprising: reporting the unplanned well activity in a well plan report.

Embodiment 15. The method of embodiment 13, further comprising: inserting the unplanned well activity into a future digital well plan for drilling a future wellbore, thereby modifying the future digital well plan to include the unplanned well activity.

Embodiment 16. The method of embodiment 1, wherein when the confidence level is below a predetermined value, thereby indicating a low level of confidence that the estimated well activity is an actual well activity.

Embodiment 17. The method of embodiment 16, further comprising: requesting user input, via the rig controller, to adjust the confidence level based on a user's awareness of the actual rig tasks; receiving the user input; and adjusting the confidence level based on the user input.

Embodiment 18. The method of embodiment 17, further comprising: adjusting the confidence level above the predetermined value; comparing the actual well activity to an expected well activity of the digital well plan; determining that the actual well activity is not the expected well activity of the digital well plan; and identifying the actual well activity as an unplanned well activity.

Embodiment 19. The method of embodiment 18, further comprising: inserting the unplanned well activity into a future digital well plan, thereby modifying the future digital well plan to include the unplanned well activity.

Embodiment 20. The method of embodiment 19, further comprising: reporting the unplanned well activity in a well plan report.

Embodiment 21. The method of embodiment 17, further comprising: adjusting the confidence level above the predetermined value; comparing the actual well activity to an expected well activity of the digital well plan; determining that the actual well activity is the expected well activity of the digital well plan; identifying the actual well activity as a planned well activity; and monitoring the sensor data to determine when the actual well activity changes.

Embodiment 22. The method of embodiment 17, further comprising: adjusting the confidence level below the predetermined value; A) monitoring the sensor data; B) determining the actual well activity; C) determining the estimated well activity; D) comparing the actual well activity to the expected well activity in the digital well plan; and E) setting the confidence level for the estimated well activity; and F) repeating operations A-E until the confidence level is above the predetermined value.

Embodiment 23. The method of embodiment 22, further comprising: comparing the actual well activity to an expected well activity of the digital well plan; and determining that the actual well activity is a planned well activity or an unplanned well activity.

Embodiment 24. A method for performing subterranean operations, the method comprising: collecting one or more parameters from one or more data sources, wherein the one or more parameters are representative of at least one condition that affects at least one operation of a rig; based on the one or more parameters, determining rig tasks being performed at the rig; based on the rig tasks, determining a well activity for the rig; identifying secondary operations that are occurring at the same time as primary activities; comparing, via a rig controller, the secondary operations to a digital well plan; and based on the comparing, determining whether the secondary operations are occurring at a proper time to support future primary activities.

Embodiment 25. The method of embodiment 24, wherein the primary activities comprise rig tasks that directly impact the execution of the digital well plan, and wherein secondary operations comprise rig tasks that indirectly support execution of the digital well plan.

Embodiment 26. The method of embodiment 25, wherein the well activity of the digital well plan requires running a drill string into a wellbore.

Embodiment 27. The method of embodiment 26, wherein the primary activities for the well activity comprise a pipe handler retrieving tubulars from a tubular storage, and a top drive receiving the tubulars from the pipe handler and repeatedly connecting individual tubulars to an upper end of the drill string, thereby extending the drill string into the wellbore.

Embodiment 28. The method of embodiment 27, wherein the secondary operations comprise: verifying that a number of tubulars needed to support the running the drill string into the wellbore is contained in the tubular storage; and requesting, via the rig controller, additional tubulars be added to the tubular storage if the number of tubulars is not sufficient to support the running of the drill string.

Embodiment 29. The method of embodiment 27, wherein the secondary operations comprise: verifying that a number of tubulars needed to support the running the drill string into the wellbore is contained in the tubular storage and that the tubulars are a correct diameter for the primary activities; and requesting, via the rig controller, additional tubulars be added to the tubular storage if the number of tubulars is not sufficient to support the running of the drill string.

Embodiment 30. The method of embodiment 24, wherein the secondary operations comprise: a forklift operation, a crane operation, a maintenance operation, pipe storage management, a mud treatment operation, tool storage management, supplies management, an inspection operation, a shipment operation, a delivery operation, rig power system management, rig power system status, energy storage system management energy storage status environmental conditions, environmental forecasts, personnel management, assigning alternates for rig personnel in case operational personnel become unavailable, production forecasts, and combinations thereof.

Embodiment 31. The method of embodiment 24, wherein the one or more parameters comprises at least one of: rotations per minute (RPM) of a drill string, rate-of-penetration (ROP) of the drill string, hook load, pump pressure, stand-pipe pressure, weight on bit (WOB), state of one of more mud pumps, shaker powered on, gas analyzer, one or more pipe handlers operating, information from a rig report, information from a supplier, information from a driller, information from a user, information from an operator, information from a maintenance operator, information from a maintenance operation, information from rig equipment, information from supply management, information from maintenance operations, information from the management of personnel, and combinations thereof.

Embodiment 32. A system configured to carry out any of the methods described herein.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

1. A method for performing subterranean operations, the method comprising:
collecting sensor data from one or more data sources, wherein the sensor data is representative of conditions at a rig;
based on the sensor data, determining actual rig tasks being performed at the rig;
based on the actual rig tasks, determining an estimated well activity for the rig;
comparing the actual rig tasks to expected rig tasks in a digital rig plan;
based on the comparing, setting a confidence level for the estimated well activity, wherein the confidence level indicates a degree of confidence in an accuracy of the estimated well activity being an actual well activity; and
comparing, via a rig controller, the estimated well activity to an expected well activity in a digital well plan.

2. The method of claim 1, further comprising requesting user input regarding the confidence level.

3. The method of claim 2, further comprising receiving the user input and adjusting the confidence level of the estimated well activity based on the user input.

4. The method of claim 2, further comprising;
requesting the user input via a rig controller;
receiving the user input from an input device;
adjusting the confidence level based on the user input; and
altering the estimated well activity to indicate another well activity based on the user input when the confidence level is below a predetermined value.

5. The method of claim 1, wherein the confidence level being above or equal to a predetermined value indicates a high level of confidence that the estimated well activity is the actual well activity, and wherein the estimated well activity is a planned well activity, and wherein the planned well activity is an expected well activity according to the digital well plan since the estimated well activity correlates with the expected well activity of the digital well plan.

6. The method of claim 1, wherein the confidence level being below a predetermined value indicates a low level of confidence that the estimated well activity is the actual well activity, further comprising requesting user input regarding the confidence level, wherein, based on the user input, the confidence level is adjusted to be above or equal to a predetermined value, wherein the estimated well activity is a planned well activity, and wherein the planned well activity is an expected well activity according to the digital well plan since the estimated well activity correlates with an expected well activity of the digital well plan.

7. The method of claim 6, further comprising training a machine learning processor based on the user input to improve results of the machine learning processor.

8. The method of claim 1, wherein when the confidence level is above a predetermined value, thereby indicating a high level of confidence that the estimated well activity is an actual well activity, further comprising:
comparing the actual well activity to an expected well activity of the digital well plan;
determining that the actual well activity is not the expected well activity of the digital well plan; and
identifying the actual well activity as an unplanned well activity.

9. The method of claim 8, further comprising:
training a machine learning processor based on the unplanned well activity to improve results of the machine learning processor when generating a future well plan for drilling a future wellbore.

10. The method of claim 8, further comprising:
inserting the unplanned well activity into a future digital well plan for drilling a future wellbore, thereby modifying the future digital well plan to include the unplanned well activity.

11. The method of claim 8, further comprising:
modifying the digital well plan to handle the unplanned well activity and to produce a modified digital well plan to handle a future unplanned well activity; and
continuing to drill a current wellbore based on the modified digital well plan.

12. The method of claim 1, wherein when the confidence level is below a predetermined value, thereby indicating a low level of confidence that the estimated well activity is an actual well activity.

13. The method of claim 12, further comprising:
requesting user input, via the rig controller, to adjust the confidence level based on a user's awareness of the actual rig tasks;
receiving the user input; and
adjusting the confidence level based on the user input.

14. The method of claim 13, further comprising:
adjusting the confidence level above the predetermined value;
comparing the actual well activity to an expected well activity of the digital well plan;
determining that the actual well activity is not the expected well activity of the digital well plan; and
identifying the actual well activity as an unplanned well activity; and
inserting the unplanned well activity into a future digital well plan, thereby modifying the future digital well plan to include the unplanned well activity.

15. The method of claim 13, further comprising:
adjusting the confidence level above the predetermined value;
comparing the actual well activity to an expected well activity of the digital well plan;
determining that the actual well activity is the expected well activity of the digital well plan;
identifying the actual well activity as a planned well activity; and
monitoring the sensor data to determine when the actual well activity changes.

16. The method of claim 13, further comprising:
adjusting the confidence level below the predetermined value;
A) monitoring the sensor data;
B) determining the actual well activity;
C) determining the estimated well activity;
D) comparing the actual well activity to the expected well activity in the digital well plan; and
E) setting the confidence level for the estimated well activity; and
F) repeating operations A-E until the confidence level is above the predetermined value.

17. A method for performing subterranean operations, the method comprising:
collecting a parameter from one or more data sources, wherein the parameter comprises one or more parameters, and wherein the parameter is representative of at least one condition that affects at least one operation of a rig;
based on the one or more parameters, determining rig activities being performed at the rig;
based on the rig activities, determining a rig state for the rig;
identifying secondary path activities that are occurring at a same time as primary path activities;
comparing, via a rig controller, the secondary path activities to a digital rig plan; and
based on the comparing, determining whether the secondary path activities are occurring at a proper time to support future primary path activities.

18. The method of claim 17, wherein the primary path activities comprise rig activities that directly impact execution of the digital rig plan, and wherein secondary path activities comprise activities that indirectly support execution of the digital rig plan, wherein the rig state of the digital rig plan requires running a drill string into a wellbore, and wherein the primary path activities for the rig state comprise a pipe handler retrieving tubulars from a tubular storage, and a top drive receiving the tubulars from the pipe handler and repeatedly connecting individual tubulars to an upper end of the drill string, thereby extending the drill string into the wellbore.

19. The method of claim 18, wherein the secondary path activities comprise:
verifying that a number of tubulars needed to support the running the drill string into the wellbore is contained in the tubular storage; and
requesting, via the rig controller, additional tubulars be added to the tubular storage if the number of tubulars is not sufficient to support the running of the drill string.

20. The method of claim 18, wherein the secondary path activities comprise:
verifying that a number of tubulars needed to support the running the drill string into the wellbore is contained in the tubular storage and that the tubulars are a correct diameter for the primary path activities; and
requesting, via the rig controller, additional tubulars be added to the tubular storage if the number of tubulars is not sufficient to support the running of the drill string.
